(19) United States
(12) Patent Application Publication
(10) Pub. No.: US 2026/0368498 A1
(43) Pub. Date: Nov. 19, 2026

(54) GENERATING RESEARCH SUB-TASKS USING GENERATIVE MODELS AND RESOURCE CONTENT

(71) Applicant: GDM Holding LLC, Mountain View, CA (US)

(72) Inventors: Mukund Harakere Sridhar, Mountain View, CA (US); Ester Hlavnova, New York, NY (US); Parthasarathy Gopavarapu, Fremont, CA (US); Shuli Liu, Castro Valley, CA (US); Brian Baugh, Seattle, WA (US); Altaf Rahman, South San Francisco, CA (US); Geunseob Oh, New York, NY (US); Aarush Selvan, New York, NY (US); Rupashree Bhattacharya, Santa Clara, CA (US); Kushal Majmundar, Mountain View, CA (US); Guangxing Han, New York, NY (US); Rushin Shah, Fremont, CA (US); Naman Goyal, Cupertino, CA (US)

(21) Appl. No.: 19/657,826

(22) Filed: Apr. 24, 2026

Related U.S. Application Data
(60) Provisional application No. 63/808,388, filed on May 19, 2025.

(51) Int. Cl. G06N 3/0475

(52) U.S. Cl. CPC G06N 3/0475

(57) ABSTRACT

Some implementations herein relate to a computer-implemented process for generating research outputs. The process can include identifying user input related to a research task for one or more generative models (GMs), identifying resources based on the input, generating a prompt based on the input and resource content for processing by the GMs, and processing the prompt to generate research sub-tasks. Indications of the sub-tasks can be rendered to the user, and a user interaction related to the sub-tasks and/or the resources provided can then be identified. Based on this interaction, performance of the sub-tasks can generate data using the resources and GMs. Content based on this data can then be rendered to the user. Other implementations might be described and/or claimed.

### BACKGROUND

The efficient retrieval, selection, and utilization of relevant resources can be considered to be a challenge in various technological domains. In information retrieval systems, one legacy approach can involve keyword-based searches, where users input specific terms, and the system returns documents containing those terms. However, these systems can suffer from limitations in precision and recall. Precision can be limited because keyword matching might not capture the semantic meaning of the user's input, and therefore produce irrelevant results. Recall can be limited because documents that do not explicitly contain the keywords might still be relevant based on the semantic meaning of the input, but are missed by the search due to their lack of exact keyword matching.

To address these limitations, some legacy semantic search techniques have been developed. Some legacy examples of semantic search might aim to understand the intent and context behind a user's input, rather than simply matching keywords. For example, these techniques might employ natural language processing (NLP) and machine learning models to analyze the meaning of both the user's input and the documents being searched. Some examples of these techniques might use word embeddings, which can represent words as vectors in a high-dimensional space, thereby capturing semantic relationships between words. Documents and inputs can then be represented as vectors, and similarity measures, such as cosine similarity, can be used to rank documents based on their relevance to the user's input.

However, legacy semantic search systems might still face challenges. One example challenge is referred to as the "cold start" problem, where the system has limited information about the user's specific needs or preferences. This limited information can make it difficult to provide relevant results, especially for complex or nuanced queries. Another example challenge is the efficient handling of large document collections. Calculating semantic similarity between a user's input and a vast number of documents can be computationally expensive, requiring specialized indexing techniques and hardware acceleration. Furthermore, current systems often struggle to effectively incorporate diverse data sources, such as structured databases, multimedia content, and internal knowledge repositories, thereby limiting the scope and depth of the research process.

### SUMMARY

Some implementations herein relate to identifying user input by a user to an electronic device. The user input can be related to a research task that is to be performed using one or more generative models (GMs). Some implementations may be further directed to identifying one or more resources that are to be used for performance of the research task, based on the user input. Further, the implementations can relate to generating a prompt related to the research task for processing using the one or more GMs, wherein the prompt is based on the user input and content of at least one of the one or more resources. The prompt can be processed using the one or more GMs to generate one or more research sub-tasks that are related to the research task. One or more indications of the one or more research sub-tasks can then be rendered to the user.

In some implementations, a user interaction (which could be passive or active) with the electronic device might then occur and be identified. In these implementations, the user interaction could be related to the one or more research sub-tasks. Performance of the one or more research sub-tasks could then be caused based on identification of the user interaction to generate data using the one or more resources and the one or more GMs. In some implementations, performance of the one or more research sub-tasks may additionally or alternatively use one or more additional GMs. Content that is based on the data that results from performance of the one or more research sub-tasks could then be rendered to the user.

In some implementations, the user-provided feedback could take the form of adding, selecting, de-selecting, and/or editing one or more of the sub-tasks and/or the prompt. In these implementations, one or more of the previously generated sub-tasks could be edited, or a new sub-task could be generated, based on the edited, introduced, selected, or de-selected sub-task.

In some implementations, the user feedback could involve providing or otherwise identifying another user-provided resource. In these implementations, one or more of the previously generated sub-tasks could be edited, or a new sub-task could be generated, based on content of the user-provided resource.

Implementations disclosed herein can mitigate (i.e., reduce or eliminate) various of the above-described drawbacks associated with legacy techniques. For example, the cold start problem can be addressed by using the content of uploaded resources to generate targeted prompts for the generative models, thereby providing initial context and guidance. As another example, the computational expense of processing large document collections can be reduced by prioritizing the content of the selected resources when generating the prompts, allowing the GMs to focus on the most relevant information and reducing the need to process a vast number of irrelevant documents. As another example, the ability to incorporate diverse data sources can be improved by structuring the generated prompts to effectively utilize both the content of the selected resources and data from other sources, such as structured databases or internal knowledge repositories.

As a non-limiting example of some implementations disclosed herein, consider a scenario where a patent attorney is tasked with drafting a patent application for a new type of artificial intelligence-powered medical diagnostic tool. The attorney might upload several resources, such as scientific publications describing the underlying technology, prior art patents in the field, and internal research reports. The system could then analyze the content of these resources and generate prompts for generative models (GMs) to perform research sub-tasks. For example, one research sub-task could be to identify the key distinguishing features of the new diagnostic tool compared to existing solutions, based on the content of the uploaded scientific publications and prior art patents. Another research sub-task could be to generate claims of varying scope that cover the novel aspects of the invention. The system might then generate draft claim language for the attorney's review, thereby generating data using the uploaded resources and the GMs, with the draft claim language ultimately being presented to the attorney to assist in the drafting of a patent application.

As another non-limiting example of some implementations disclosed herein, consider a scenario where a marketing analyst is tasked with creating a report on emerging trends in the electric vehicle (EV) market. The analyst might upload market research reports, competitor analysis documents, and internal sales data as resources. The system could present an initial draft of research sub-tasks to the analyst based on the analyst's input and the content of one or more of the reports, such as "Identify the top 5 EV models by sales volume in the last quarter," "Analyze consumer sentiment towards different EV brands on social media," and "Summarize the key findings from the uploaded market research reports." The analyst could then actively select or deselect sub-tasks based on their relevance to the report, edit the sub-tasks to refine their scope, or provide additional user-provided resources. Alternatively, if the analyst doesn't interact within a predefined timeframe (e.g., 5 minutes), the system might passively proceed with the default sub-task selection. Based on this user input (active or passive), the system could iterate and present additional or alternative sub-tasks, such as "Compare the battery technology used in the top 3 EV models" or "Identify potential partnerships between EV manufacturers and charging infrastructure providers," thereby refining the research plan and generating more targeted data for the final report. In some implementations, such iteration could be based on the content of the document that is provided after the initial rendering of the various sub-tasks.

In some implementations, the one or more research sub-tasks might relate to the resources and/or sub-tasks. For example, one research sub-task could relate to gathering additional external resources. For example, if one sub-task is "Identify potential partnerships between EV manufacturers and charging infrastructure providers," then another research sub-task could be "search for public filings of co-ownership between EV manufacturers and charging infrastructure providers." Alternatively, if the user-provided documents include such public filings, or if then user wanted to specifically synthesize data from one or more known resources, then a research sub-task could be "Exclude external content related to public filings of co-ownership between EV manufacturers and charging infrastructure providers."

As previously noted, in some scenarios, after an initial set of research sub-tasks are presented to the user, the user might want to modify the sub-tasks prior to execution. For example, the user could edit the initially-proposed research sub-tasks to clarify the scope or to focus on particular aspects of the research task. The user could also modify the resources used in performance of the research task, such as adding new resources, removing existing resources, or reordering the resources. If such changes are identified, some implementations can generate a second prompt that reflects these modifications. This second prompt can then be processed using the GMs and the revised resources to generate a change (e.g., an alteration or addition) to one or more of the sub-tasks. Prior to performance of the changed or added research sub-task(s), some implementations can render an indication of the changed sub-task(s) to the user and identify a second user interaction with the electronic device that relates to the sub-task(s) (e.g., passive or active selection, de-selection, etc.) This process can iterate until the user approves of the presented one or more sub-tasks.

Some implementations can further relate to identifying a data representation of a portion of the content (which may additionally or alternatively be referred to herein as an “element”) that is to be rendered based on data resulting from a research sub-task. In these implementations, the GMs can generate a portion of the content based on the data and the identified data representation. For example, the data representation can be a textual data representation, such that the generated portion of the content is rendered as a textual element. Alternatively, the data representation can be a non-textual visual data representation, such that the generated portion of the content is rendered as a non-textual visual element. As another example, the data representation can be a non-textual audio data representation, such that the generated portion of the content is rendered as an audio element. As another example, the data representation can be an interactive data representation, such that the generated portion of the content is rendered as an interactive element.

Some implementations can relate to situations where the resources that are used for performance of the research task are user-provided resources, as previously described. In some such scenarios, a research sub-task can include processing the content of the user-provided resources. In some of those scenarios, a research sub-task can further include excluding content from resources that are different from the user-provided resources. For example, the user could upload scientific papers describing a particular drug, and the initial sub-task could relate to summarizing the findings of those papers. A secondary sub-task could be to exclude content that is not present in the user-provided documents (e.g., content from the internet or some other source).

Some implementations relate to the generation of research sub-tasks based on various factors, such as a topic of a resource, a type of a resource, and/or a topic of the research task. For example, if a user uploads a market research report on electric vehicles, the system might generate research sub-tasks related to electric vehicle sales figures, consumer preferences, or charging infrastructure. As another example, if a user uploads a scientific article, the system might generate research sub-tasks to summarize the key findings, identify the research methodology, or search for related articles.

Generally, resources can take a plurality of different forms or modalities. For example, the resources can include textual content such as documents, articles, reports, and specifications. Some resources could additionally or alternatively include visual content such as charts, graphs, images, and diagrams. Some resources could include video content, which could be streamed from online sources or accessed from local storage. Some resources could include audio content such as podcasts, music, and voice recordings. Some resources could be structured data such as databases, spreadsheets, and extended markup language (XML) files. These resources can be accessed from external sources such as the internet or internal sources such as the user's computer, one or more locations of the user's organization or network (e.g., a server), or other locations. It will be understood that the preceding is intended as non-limiting examples of such resources, and other implementations can include one or more additional or alternative types of resources.

Implementations herein can be described with respect to a vision language model (VLM). As used herein, a VLM can refer to a type of GM that is capable of accepting inputs in a variety of modalities such as text-based inputs and vision-based inputs. In implementations, the text-based inputs can be based on inputs that are typed by a user into the phone via a keyboard that is presented to the user on the screen of the phone, wirelessly coupled with the phone, coupled with the phone by a wired connection, etc. In other implementations, the text-based inputs can be based on or related to a transcription of an audio input by the user (e.g., via a speech-to-text program). In these implementations, the text-based input can be in a user-readable form or in some type of machine language or non-user readable form. Based on the input, the VLM can generate and/or provide an output in one or more modalities including a text-based output, a visual output, an audio output, and/or some other type of output.

It will be understood that the use of VLM in herein is intended as a non-limiting for the sake of example and discussion. Other implementations can include one or more additional or alternative GMs such as a large language model (LLM), a recurrent neural network (RNN), a transformer model, and/or some other type of GM.

The preceding is presented as an overview of only some implementations disclosed herein. These and other implementations are disclosed in additional detail herein.

### BRIEF DESCRIPTION OF THE DRAWINGS

FIG. 1 schematically depicts an example environment in which selected aspects of the present disclosure may be implemented, in accordance with various implementations.

FIG. 2 depicts an example of a user interface, in accordance with various implementations.

FIG. 3 depicts an alternative example of a user interface, in accordance with various implementations.

FIG. 4 depicts an alternative example of a user interface, in accordance with various implementations.

FIG. 5 depicts an alternative example of a user interface, in accordance with various implementations.

FIG. 6 depicts an example of a research report, in accordance with various implementations.

FIG. 7 depicts an example process, in accordance with various implementations.

FIG. 8 schematically depicts an example architecture of a computer system, in accordance with various implementations.

### DETAILED DESCRIPTION

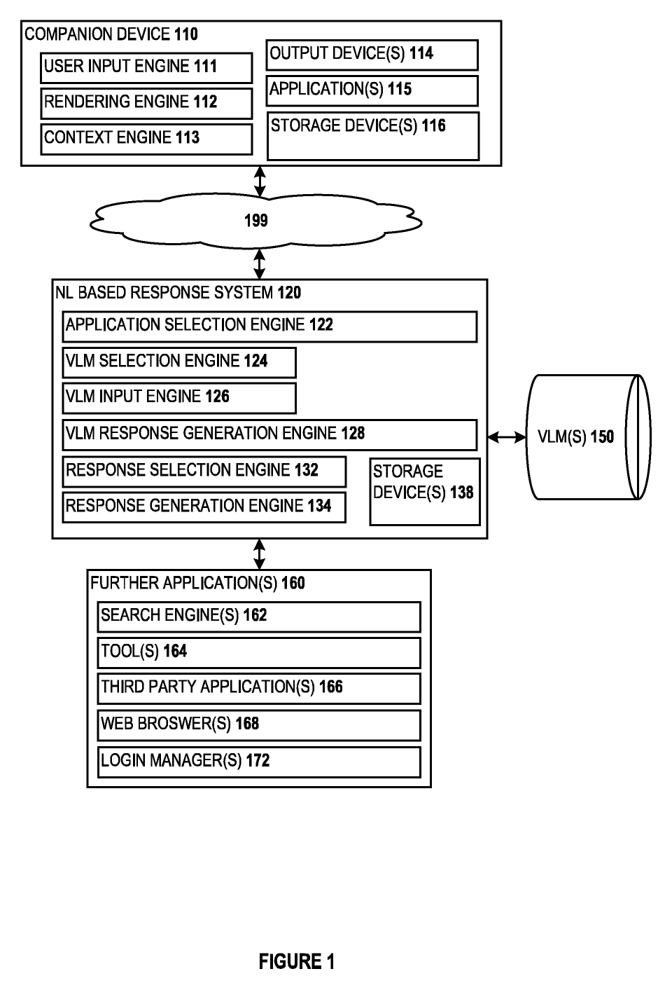

Turning now to FIG. 1, a block diagram of an example environment that demonstrates various aspects of the present disclosure, and in which implementations disclosed herein can be implemented, is depicted. The example environment can include a companion device 110, a natural language (NL) response system 120, and one or more further applications 160 (e.g., applications external to a VLM or a dialogue application executed on the companion device 110).

Although illustrated as separate elements in FIG. 1, in some implementations, all or aspects of the NL based response system 120 and/or all or aspects of the one or more further applications 160 can be implemented as part of a cohesive system. In some implementations, all or aspects of the NL based response system 120 and/or the further applications 160 can be implemented locally at the companion device 110 (e.g., as part of a single physical unit such as a single cellular telephone, personal digital assistant (PDA), tablet device, laptop, desktop computer, etc.). In additional or alternative implementations, all or aspects of the NL based response system 120 and/or one or more electronic devices that implement or include the further applications 160 can be implemented remotely from the companion device 110 as depicted in FIG. 1 (e.g., at one or more remote server(s)). In those implementations, the companion device 110 and the NL based response system 120 and/or the electronic device(s) that implement the further application(s) 160 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet, one or more cellular networks, one or more satellite-based networks, etc.).

The companion device 110 can be, for example, one or more of: a desktop computer, a laptop computer, a tablet, a mobile phone, a PDA, a computing device of a vehicle (e.g., an in-vehicle communications system, an in-vehicle entertainment system, an in-vehicle navigation system), a standalone interactive speaker having a display, a smart appliance such as a smart television or smart refrigerator, and/or a wearable apparatus of the user that includes a computing device (e.g., a watch of the user having a computing device, glasses of the user having a computing device, a virtual or augmented reality computing device, etc.). Additional and/or alternative companion devices can be provided.

The companion device 110 can execute one or more applications, such as application(s) 115, via which user input related to a research task can be submitted and/or research results can be rendered (e.g., audibly and/or visually). The application(s) 115 can be an application that is separate from an operating system of the companion device 110 (e.g., one installed “on top” of the operating system) – or can alternatively be implemented directly by the operating system of the companion device 110. For example, the application(s) 115 can be a web browser installed on top of the operating system (OS), or can be an application that is integrated as part of the operating system functionality. The application(s) 115 can interact with the NL based response system 120.

In various implementations, the companion device 110 can include a user input engine 111 that is configured to detect user input provided by a user of the companion device 110 using one or more user interface input devices. For example, the companion device 110 can be equipped with one or more microphones that capture audio data, such as audio data corresponding to spoken utterances of the user or other sounds in an environment of the companion device 110. Additionally, or alternatively, the companion device 110 can be equipped with one or more vision components that are configured to capture vision data corresponding to images and/or movements (e.g., gestures) detected in a field of view of one or more of the vision components. Additionally, or alternatively, the companion device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the companion device 110.

In various implementations, the companion device 110 can include a rendering engine 112 that is configured to provide content (e.g., research results generated based on a research task) for audible and/or visual presentation to a user of the companion device 110 using one or more output devices 114. For example, the output device(s) 114 can be or include one or more speakers that enable content to be provided for audible presentation to the user via the companion device 110. Additionally or alternatively, the output device(s) 114 can be or include one or more monitors or screens on which one or more visual elements can be displayed. Additionally or alternatively, the output device(s) 114 can be or include an alternative type of output device such as a haptic feedback device. Generally, the rendering engine 112 can be configured to receive digital content and facilitate changing the digital content to a user-recognizable format (e.g., sound, one or more visual elements, etc.)

In various implementations, the companion device 110 can include a context engine 113 that is configured to determine a context (e.g., current or recent context) of the companion device 110 and/or of a user of the companion device 110. In some of those implementations, the context engine 113 can determine a context utilizing current or recent interaction(s) via the companion device 110 (e.g., recent input received from, and/or output provided to, a user of the companion device 110), a location of the companion device 110, profile data of a profile of a user of the companion device 110 (e.g., an active user when multiple profiles are associated with the companion device 110), and/or other data accessible to the context engine 113.

As an example, the context engine 113 can determine a current context based on which application is active in the foreground of the companion device 110, a current or recent state of the active application, and/or content currently or recently rendered by the active application. A context determined by the context engine 113 can be utilized, for example, in supplementing or rewriting a prompt that is formulated based on user input, in generating an implied prompt (e.g., a prompt formulated independent of user input), and/or in determining to submit an implied prompt. In some implementations, a context can be based on one or more previous user interactions with the companion device 110 and/or the NL based response system 120 that were related to a same or similar topic.

The companion device 110 can additionally include one or more storage devices 116. In various implementations, the storage device(s) 116 can be implemented as memory such as non-volatile memory (NVM) like flash memory, a hard disk drive (HDD), read-only memory (ROM), etc. In some implementations, the storage device(s) 116 can be additionally or alternatively implemented as volatile memory such as cache memory, random access memory (RAM), etc. The storage device(s) can, in some implementations, store data and/or one or more software applications (e.g., application(s) 115).

Although not explicitly shown, in some implementations the companion device 110 and/or the NL based response system 120 can include one or more processors for accessing data and executing the software applications (e.g., application(s) 115), and/or other components that facilitate communication over one or more of the networks 199. In some implementations, one or more of the software applications can be installed locally at the companion device 110, whereas in other implementations one or more of the software applications can be hosted remotely (e.g., by one or more servers) and can be accessible by the companion device 110 over one or more of the networks 199.

Although aspects of FIG. 1 are illustrated or described with respect to a single companion device having a single user, it should be understood that such description is for the sake of example and is not meant to be limiting. For example, one or more additional companion devices of a user and/or of additional user(s) can also implement the techniques described herein. For instance, the companion device 110, the one or more additional companion devices, and/or any other computing devices of a user can form an ecosystem of devices that can employ techniques described herein. These additional companion devices and/or computing devices can be in communication with the companion device 110 (e.g., over the network(s) 199). As another example, a given companion device can be utilized by multiple users in a shared setting (e.g., a group of users, a household).

The example NL based response system is illustrated as including an application selection engine 122, a VLM selection engine 124, a VLM input engine 126, a VLM response generation engine 128, a response selection engine 132, a response generation engine 134, and one or more storage devices 138. It will be understood that, in various implementations, various of the engines and/or components can be omitted, combined, or otherwise altered from the configuration depicted. For example, in some implementations, one or more of the engines of the NL based response system 120 can be distributed across one or more computing systems (which might or might not include the companion device 110).

In general, NL based response system 120 can be configured to receive natural language input (or data related to the natural language input such as a machine-readable indication of such input) and context generated by the companion device 110 (e.g., by the context engine 113), and to generate a prompt based on the natural language input, the context, and/or one or more additional or alternative elements or factors as described below. The NL based response system 120 can then process the prompt to generate a response to the user's input. As is further described in the following, in some implementations such processing can be recursive such that processing of one or more prompts can lead to the generation of one or more additional prompts, which can then be subsequently processed. Such recursiveness could be cause by a variety of example factors such as user changes to the resource(s), user changes to the research task and/or one or more of the research sub-tasks, data produced by at least partially processing the prompt, etc.

In some implementations, VLM input engine 126 can, in response to receiving the user input, generate VLM input (i.e., a prompt) that is to be processed using one or more VLMs. In various implementations, the prompt can be based on a variety of factors or elements. For example, in some implementations, the prompt can be based on the received user input. Additionally or alternatively, the prompt can be based on the context provided by context engine 113. Additionally or alternatively, the prompt can be based on at least partial processing of one or more previous prompts. For example, the VLM input engine 126 could be configured to generate a prompt based on, or otherwise related to, one or more research sub-tasks that were previously generated based on a previous prompt.

In some implementations, the prompt can be based on one or more identified resources, and/or content thereof. In some implementations, such resources can be or include, for example, user-input resources, one or more-preidentified resources, and/or dynamically identified information resources. The dynamically-identified resources can be based on, for example, a topic of the user's input, and the system can be enabled (e.g., through a research sub-task or some other mechanism) to search for additional resources based on the topic. Such resource could take the form of, for example, searching the internet, searching through one or more local or remote databases, etc.. Such resources can be or include, for example, webpages, social media, academic articles, caselaw, video content, and/or some other type or style of content.

In some implementations, the resources can additionally or alternatively include resources such as files on the user’s computer, or on a computer (e.g., another workstation or a server) of the user’s and/or the user’s organization. In some implementations, the resources could be stored remotely (e.g., in a cloud drive or some other remote storage location). In these implementations, the user might (either at the time of processing the prompt or prior to provision of the user’s input) provide one or more indications of one or more locations of the user’s computer and/or other computers of the network where the system can search for resources. For example, the user may configure specific computers, specific directories, etc. in which the system can acquire resources for use in generating or processing the prompt. In these implementations, the system might be programmed to refrain from searching other locations of the user’s computer and/or the remote or local computer’s of the user’s network or organization.

In some implementations, the prompt could be based on additional user input such as selection or de-selection of one or more candidate resources, addition or replacement of a user-provided resource, selection or de-selection of one or more presented research sub-tasks, editing of a resource and/or research sub-task, editing of the prompt, etc.

In some implementations, as described elsewhere herein, the prompt might relate to a research task provided by the user. In other words, the user might provide, for example via the user input engine 111, natural language input that is related to a research topic. Based on this prompt, the NL based response system 120 can perform one or more actions as described herein such as identifying one or more research sub-tasks, identifying one or more GMs to be used in the performance of one or more of the sub-tasks, generating a new prompt based on user feedback or data that results from performance of at least one of the sub-tasks, identifying one or more resources that are to be used or excluded from use for performance of the research task (and/or sub-tasks), generating one or more sub-tasks related to generating and/or rendering an element in a given data representation, identifying a data representation with which to render or present the data, and/or performing the one or more sub-tasks to generate a data.

In some implementations, the prompt can be based on an attribute of the user. For example, if profile information related to the user is included in the context provided by context engine 113, then the prompt could include one or more indications of the user’s profile. For example, the prompt could include an indication that the user is an experienced electrical engineer. Based on this indication, candidate response(s) that relate to explanation of basic circuit diagrams or basic electrical engineering concepts could be avoided when generating and/or evaluating the one or more candidate responses. Similarly, if the prompt includes an indication that the user likely speaks a particular language (e.g., French) better than the user speaks English (for example, if the user’s profile indicates that the user was born and lives in France), then the candidate response(s) that are in English could be avoided, and response(s) that are in French could be prioritized.

In some implementations, the prompt could additionally or alternatively be based on information or instructions that are to be followed by the VLM input engine 126 in generation of the prompt. The information or instructions could be pre-configured, or could be dynamically identified (e.g., by a recursive process of the NL based response system 120) based on some other factor such as one or more of the resources, user feedback, data that results from performance of one or more sub-tasks, etc.

In some implementations, the application selection engine 122 can, in processing the prompt, determine one or more further applications 160 to invoke. The application selection engine 122 can select applications that are relevant to the user's input, e.g., determine that the user's input is directed towards subject matter within the domain of one or more further applications 160, and select/invoke one or more of the further applications 160 in response. For example, if generating a response to the prompt involves utilization of a webpage (for example, as a resource or for provision to a user as a result of processing of the prompt), then the application selection engine 122 can select a web browser application as one of the one or more further applications 160 to then access the webpage. It should be understood that the specifically depicted applications of FIG. 1 are depicted for the sake of example only, and the one or more further applications 160 can include some other application that is accessible at the companion device 110 and/or the NL based response system 120.

The VLM selection engine 124 can, in response to receiving a prompt, determine which, if any, of multiple GMs (e.g., VLM(s) 150 and/or one or more other multi-modal GMs) to utilize in generating response(s) to the prompt. For example, the VLM selection engine 124 can select none, one, or multiple GMs to utilize in generating response(s) in furtherance of processing the prompt. In some implementations, the VLM selection engine 124 can optionally utilize one or more classifiers and/or rules (not illustrated).

The VLM response generation engine 128 can process the prompt using a VLM such as one of VLMs 150, to generate one or more candidate responses that are responsive to the user's input. The candidate responses can include, for example, results of performing a research task or one or more of the research sub-tasks to generate data. In some implementations, the processing of one or more of the sub-tasks and/or the generation of the one or more candidate responses could be performed by one or more GMs that are different than the GMs used to, for example, generate a prompt and/or generate the one or more sub-tasks.

For example, a relatively lightweight GM with a relatively small dataset could be used for processes that are less resource intensive such as prompt generation, sub-tasks generation, generation of content with a textual data representation based on the results of processing one or more of the sub-tasks, etc. By contrast, one or more GMs with a larger dataset could be used for more resource-intensive tasks such as processing a sub-task to generate data. Similarly, one or more different GMs, which may or may not have a larger dataset, could be used to generate non-textual content with data representations such as images, interactive elements, audio content, movies, etc.

In some implementations, the relatively lightweight GMs may be stored in storage that is local to the companion device 110 (e.g., storage device(s) 116). The larger GMs (i.e., the GM(s) with larger datasets) could be stored remotely from the companion device 110 (e.g., VLM(s) 150 and/or storage device(s) 138). In these implementations, processing using the remote GMs could be performed by one or more processors that are remote from, but communicatively coupled with, the companion device 110 (e.g., one or more processors of a remote server that is communicatively coupled with the companion device 110 via the network 199). Similarly, processing using the local GMs could be performed by the companion device 110.

In this example, the NL based response system 120 could be duplicated or divided between the remote location and the companion device 110, so that local processing using local GM(s) was possible at the companion device, and remote processing using the remote GM(s) was also possible without having to repeatedly transmit data between the local and remote locations, which could incur significant costs in terms of bandwidth and latency.

It will be understood that this description of such division of the NL based response system 120 and different GMs or storage locations is provided as one non-limiting example, and the configurations or locations of such elements could vary in other implementations.

In some implementations, the candidate responses can additionally or alternatively include the generation, presentation, or rendering of one or more elements that relate to the same or different data, and have the similar or different data representations. Generally, as used herein, the term "data representation" can refer to a modality or format in which data is presented or rendered. For example, the candidate responses can include one or more textual elements and/or one or more non-textual elements. The non-textual elements can be or include, for example, an audio element, a video element, an interactive element (e.g., a quiz or some other element with which a user can interact, which could include textual content, non-textual content, and or some combination of textual and non-textual content), some other type of visual element (e.g., a picture or a graph), and/or some other type of element as described herein.

As noted, in some implementations, one or more of the selected candidate responses could relate to or include an interactive element (i.e., an element with an interactive data representation). In other words, the data that results from processing one or more of the research-subtasks could be rendered to the user as interactive content such as a quiz, a simulator, a conversational model, etc. that relate to or include the provision of information to, and receipt of information from, the user. In these implementations, the response generation engine may generate one or more computer instructions that, when executed by an electronic device such as companion device 110, cause the generation of execution of an applet, a script, one or more additional sub-tasks for processing using a GM, etc. (e.g., via further application(s) 160).

In some implementations, the data representation with which an element is rendered can be based on a variety of factors. In various implementations, the NL based response system 120 could identify a plurality of different possible data representations. Then, a subset of the possible data representations could be identified for rendering of data to the user.

For example the user could provide an explicit instruction in the user's input for a given data representation. Such an instruction could be, "prepare a pie chart that shows [data]." Based on this instruction, possible candidate data representations that did not relate to a visual data representation in the form of a pie chart could be removed.

In some implementations, the data representation can be selected based on a portion of the report in which a candidate element is to be rendered. For example, a textual data representation might be suggested and/or used more often for an executive summary section to convey high-level information concisely. By contrast, for a glossary section, a textual data representation formatted as a list of terms and definitions could be identified. In the body of the report, where detailed findings are presented, a combination of data representations might be selected. In another example, a textual explanation could be accompanied by a non-textual visual data representation such as a graph to illustrate trends or a table to present specific data points. An interactive data representation, such as a simulator, might be identified for a section discussing the practical implications of the research, allowing users to explore different scenarios. In the above-described implementations, such identification of the data representation could be performed by the NL based response system 120 using one or more GMs, which could either be local to, or remote from, companion device 110. Additionally or alternatively, such identification could be based on pre-configured correlation data such as one or more databases. Additionally or alternatively, such identification could be based on user indication (e.g., either explicit user indication or data associated with the user’s profile) or some form of keyword matching. Other identification techniques could be used in other implementations.

Additionally or alternatively, the data representation used could be identified based on the data that results from processing of one or more sub-tasks. For example, the resultant data could more naturally fit with a pie chart than another type of visual data representation and/or some other type of textual or non-textual representation. For example, if the data is inherently numerical in nature showing relative percentages, then the system could automatically identify that a pie chart or some other similar visual data representation could be used to present or render that data.

Additionally or alternatively, the type of data representation could be based on an external factor such as an attribute of the user. Such information could be identified based on, for example, the user's profile or some other information related to the user. For example, if the user was visually impaired, then the system could identify based on the user's profile that a non-textual audio data representation could be a preferable way to render the data, rather than rendering through a textual data representation.

In some implementations, the subset of candidate data representations might be based on explicit feedback from the user. For example, consider a scenario where the data represents the breakdown of renewable energy sources in a particular region. The initial rendering might be a textual summary stating, "Solar energy accounts for 40%, wind energy 30%, and hydroelectric power 30% of the region's renewable energy mix." The user, however, might provide feedback indicating that a visual representation would be more helpful. In response, the system could generate a pie chart visually displaying the same data. If the user further indicates that they are interested in understanding the potential impact of policy changes on the energy mix, the system might generate an interactive simulation that allows the user to adjust various parameters (e.g., tax incentives for solar energy) and observe the resulting changes in the pie chart in real-time. If the user had a pre-existing preference for a non-textual audio data representation, then the system could render each source's contribution as a unique musical note or tone, with volume proportional to each source's contribution to the total energy mix. The user might then provide feedback that they prefer the pie chart due to their familiarity with that data representation.

In similar implementations, the system might explicitly provide different options related to the data representation. For example, in response to a research sub-task, the system might render to the user indications of one or more data representations with which to format an element such as textual, audio, and/or non-textual (e.g., as a graph, interactive element, etc.) data representations. The user could then select (or de-select) one or more of the different options either actively or passively (e.g., through expiration of a timer) for inclusion in the subset of data representations that are to be rendered based on the generated data. Based on the user's selection, one or more sub-tasks could be generated to generate and/or render the selected data representation, either using a GM or through a non-GM based process.

To illustrate, suppose a user wants to explore different ways to present market analysis data derived from an initial research sub-task. The initial sub-task might involve analyzing sales figures and consumer preferences for a particular product. A GM could then be used to identify potential data representations to render an element based on the resultant data, such as a textual summary highlighting key statistics, a bar graph visualizing sales trends over time, or an interactive map displaying regional market share. These options can be presented to the user via a user interface of an electronic device. If the user selects the bar graph and interactive map options, the same or different GMs could then generate new sub-tasks specifically tailored to create these visualizations. For instance, one sub-task could focus on generating a dataset suitable for a bar graph, while another could involve creating an interactive map with drill-down capabilities.

In some implementations, the prompt and/or the GM selected by the VLM selection engine 124 as previously discussed could be based on an intended output of the NL based response system 120. For example, a different prompt might be generated if the user requests (explicitly or implicitly) a specific type of data representation (e.g., a visual data representation) than if the user requested another type of output (e.g., an interactive data representation). As another example, the system could perform one or more research sub-tasks to generate data. Based on the generated data, the system could create a new research sub-task that generates a prompt that is processed by the same or a different NL based response system 120 using a same or different GM. The generated prompt (and/or the GM used to process the prompt) in this scenario could be based on the data representation that is to be rendered to the user. As an example, a prompt that is related to generating an interactive data representation such as a quiz could be phrased as, “generate an interactive quiz having X features format based on the following data: [data] and VLM. [VLM1].” By contrast, a prompt that is related to generating a non-textual visual data representation such as a pie chart could be phrased as, “generate a pie chart, with a key, that reflects relevant parts of following data: [data] using VLM: [VLM2].” It will be understood that these non-limiting examples are highly simplified for the sake of discussion, and real-world implementations could use significantly more advanced prompts than are depicted herein.

To summarize the above-provided examples, various of these data representations could be identified based on the same underlying data. The identification of candidate elements having specific data representations can be based on various factors as described above, such as explicit user selection of desired representations from a presented list, implicit preferences derived from the user's profile (e.g., a preference for visual or audio data), the intended destination or section within the research report where the element will be rendered, the nature of the data generated by the research task (e.g., numerical data suggesting charts), characteristics of the research task itself, etc.

It will be understood that, in some implementations, the process can be recursive; for instance, an initial set of data representations could be identified. A first subset might then be generated based on where the element is to be rendered within the report. Indications of this subset could be presented to the user, who could then further refine the selection, leading to a final subset of elements to be generated with their respective data representations. Identifying the subset of candidate elements may be based on rendering one or more indications of the plurality of candidate elements, and identifying user input related to selection, de-selection, or an edit based on this rendering. This subset may be fewer candidate elements than the total number of candidate elements initially identified. Identifying the subset of candidate elements can also be based on identifying expiration of a timer that is related to the rendering of the one or more indications.

As has been noted, the above-described examples of the types of data representations, the factors that can be included in identifying a subset of possible data representations, etc. is intended as a generalized non-limiting example. Other factors, other types of data representations, other criteria for selection or de-selection, etc. can additionally or alternatively be present in other implementations.

In some implementations, as previously described, the candidate responses could additionally or alternatively be or include one or more new prompts. For example, if the system processes a research sub-task that generates data, then, rather than a new sub-task as previously described, a new prompt could be generated based that data. The prompt could relate to rendering the data, processing the data, etc. As another example, if the user changes one or more of the research sub-tasks or one or more resources after initial processing of the resource(s) or generation/processing of the sub-task(s), then the system could generate a new prompt based on one or more of those changes.

In some implementations, the candidate responses can additionally or alternatively be or include, for example, generation or identification of one or more sub-tasks related to the research task. For example, a user input could relate to a given research task such as “analyze a relationship between Corporate Entity X and Corporate Entity Y in the attached three documents.” The user could then provide three documents (Documents A, B, and C) for use as resources. Based on the user’s input and the content of the resources, the VLM response generation engine 128 could generate research sub-tasks such as “Analyze co-ownership interests between Entity X and Entity Y based on data from Document A,” “Analyze market overlap between Entity X and Entity Y based on Document B,” and so on.

In other words, the content of the resources themselves could be used to inform the sub-tasks that are generated based on the user’s input. These implementations could be beneficial because the research sub-tasks could be tailored to the available information, thereby increasing the relevance and usefulness of the provided sub-tasks. For example, the system could avoid using excess computing resources on generating and/or executing one or more sub-tasks that have inadequate information for such execution based on the provided resources.

It will be noted that, as discussed elsewhere herein, in some implementations the process of sub-task generation could be iterative. For example, subsequent to rendering of one or more of the sub-tasks to the user, the user could introduce a new resource, remove a previously-provided resource, and/or edit or otherwise alter one or more of the resources. Based on this change, the NL based response system 120 could generate one or more new sub-tasks based on the change to the resource(s).

In some implementations, the generated sub-task(s) could be generated based on one or more user-profile characteristics as previously described with respect to the prompt. For example, if the user speaks French, then one sub-task could be “translate one or more user-provided resources to French.” Similarly, if the user is an experienced electrical engineer, then an example sub-task could be “avoid discussion of basic concepts such as amperage, voltage, inductance, or resistance.”

In some implementations, the candidate responses can additionally or alternatively be or include, for example, identification of one or more resources that are to be used, or are not to be used, for the research task. For example, continuing with the above example related to Entities X and Y, the prompt generation by the VLM input engine 126 could take into account the user’s input of “in the attached three documents.” Based on this explicit user instruction, the VLM response generation engine 128 could generate a sub-task such as “exclude resources beyond the user-provided resources.” Conversely, if the user’s input was shortened to “analyze a relationship between Corporate Entity X and Corporate Entity Y,” then a generated sub-task could be “identify and present resources that relate to both Corporate Entity X and Corporate entity Y.”

It will be understood that the preceding descriptions are intended as non-limiting descriptions of possible responses or response types that can be generated for candidate responses, and other implementations can include one or more additional or alternative types or data.

The response selection engine 132 can then select one or more responses from, for example, the set of candidate responses output by the VLM response generation engine 128. The response selection engine 132 can, in some examples, select the candidate response with the highest confidence score for performance by the user device 110. In some examples, the response selection engine 132 can compare the confidence scores of the candidate responses to a threshold score. The threshold score could be pre-configured and/or identified based on a variety of the previously-described factors such as user profile, user input, context, etc. The selected response(s) can be selected from the set of candidate responses with a confidence score that exceeds the threshold score. If no candidate response has a confidence score that exceeds the threshold score, the response selection engine 132 can select a default response, e.g., a response that outputs a request for further information from the user (e.g., via the companion device 110).

The response generation engine 134 can convert the response selected by the response section engine 132 into one or more commands for an application that, when implemented by an application on the companion device, 110, or by one or more further applications 160 cause the application to perform the action that is related to the response. In some implementations as described herein, the action performed might be rendering (for example on a display of companion device 110 via rendering engine 112) one or more of the generated textual and/or non-textual elements of the research results based on the selected candidate response. In some implementations, the action performed might involve rendering one or more candidate resources that are to be used in the performance of the research task. In some implementations, the action performed might involve rendering one or more of the research sub-tasks that were identified or generated based on the prompt and/or the research task.

The NL based response system 120 can further include one or more storage devices 138. The one or more storage devices 138 can be similar to, and share one or more characteristics with, the one or more storage devices 116. In some implementations, for example implementations where the NL based response system 120 and the companion device 110 are implemented as a single physical unit (e.g., a smart phone or tablet or some other similar device), the one or more storage devices 116 and 138 can be the same storage device (e.g., a single storage device with no redundancy) or there can be two or more distinct storage devices or types of storage devices.

The one or more further applications 160 is illustrated as including one or more search engines 162, one or more tools 164, one or more third-party applications 164, one or more web browsers 166 and/or one or more login managers 170. Some of the applications can be omitted in various implementations. Further applications can also be included in the one or more further applications 160, such as one or more first party applications and/or other applications. The one or more further applications 160 can be executed on a virtual machine, e.g., in a secure virtual environment, such as in a secure environment in the cloud or locally on the companion device 110.

The one or more search engines 162 can receive a search request from the NL based response system 120 and/or companion device 110 and perform a search operation on a search space. The one or more search engines 162 can return one or more search results to the NL based response system 120 and/or the companion device 110. The one or more search engines 162 can include an internet search engine.

The one or more tools 164 can include, for example, applications that can be used to perform creative tasks, such as one or more image tools for creating and/or editing images, one or more document tools for reading, writing and/or editing documents, one or more audio tools for listening to, creating and/or editing audio. For example, in some implementations the one or more tools 164 could be used by one or more elements of the NL based response system 120 to generate a non-textual element as previously described. Many other examples are possible and are also contemplated herein.

The one or more third party applications 166 can include applications that are hosted and/or controlled by a third party for providing access to services that they provide. Examples of such third party applications include, but are not limited to: booking applications; e-commerce applications; translation applications; utility provider applications; calendar/diary applications; and/or the like.

The one or more web browsers 168 can be or refer to applications that provide access to internet webpages.

The one or more login managers 170 can securely store login credentials (e.g., login names, passwords, etc.) of a user for respective application and/or webpages. The login manager can automatically input relevant login details to an application when it is accessed and/or to a webpage when it is loaded. However, it should be noted that the NL based response system 120 can ensure that any login credentials are not included in any VLM input, but the response selection engine 132 and/or the response generation engine 134 can cause any needed login credentials to be utilized.

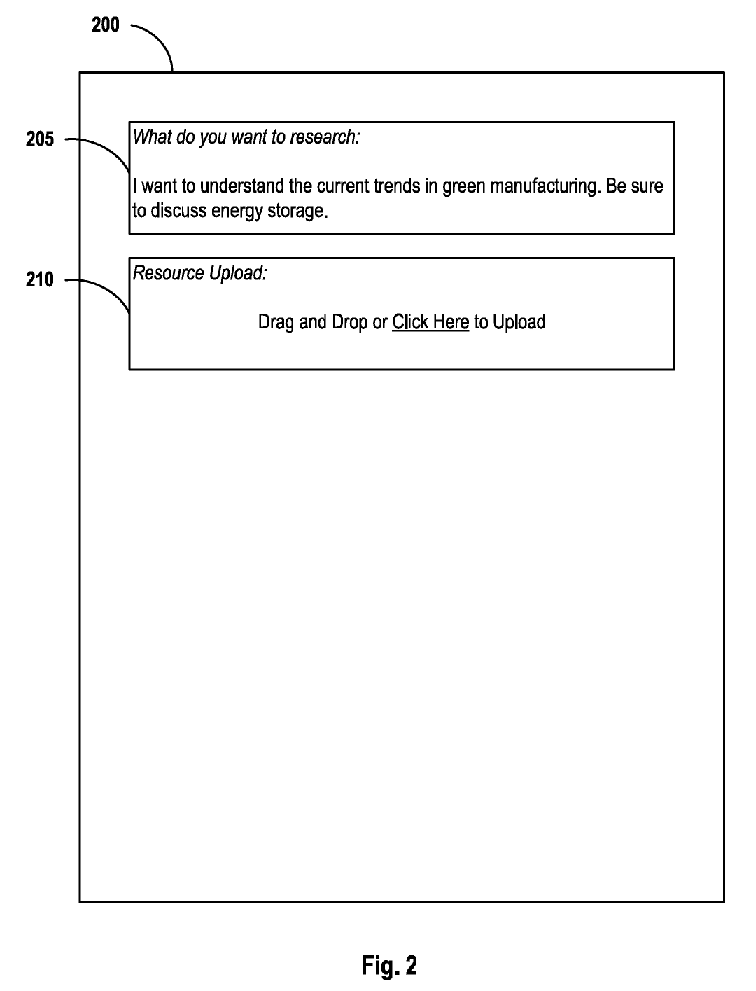

FIG. 2 depicts an example of a user interface 200 in accordance with various implementations herein. Implementations herein will be described in accordance with the example of a research task related to clean energy. However, it will be understood that this description is a non-limiting example for the sake of discussion, and implementations are not limited to a particular topic. Similarly, it will be understood that the depictions of the user interface 200 and/or various elements of the user interface 200 are intended as highly simplified non-limiting examples. The specific size, shape, orientation, wording, numbers of elements, etc. can differ in different implementations. For example, some elements can be combined, some elements can be separated into separate elements than depicted in one or more of the Figures herein, etc.

The example user interface 200 might include a user input portion 205 and a user-provided resource portion 210. In some implementations, the user can provide input to the system (e.g., a system such as that described with respect to FIG. 1) at the user input portion 205. In some implementations, the user-provided input can be, for example, written (e.g., typed) input, spoken input (such as might be translated via a speech-to-text engine), and/or some other type of input as previously described with respect to the user input engine 111. The user input can be, for example, related to a research task. In this example, the user has provided the following natural language input (e.g., using a physical or virtual keyboard): "I want to understand the current trends in green manufacturing. Be sure to discuss energy storage."

The user-provided resource portion 210 can be a portion of the user interface 200 where a user is able to upload one or more resources that are to be used by the system for the research task. For example, the user may be able to provide the resources as a document, as a portable document file (PDF), as an image file, as a video file, as an audio file, etc. The user might be able to provide the file by "clicking" or otherwise interacting with an element of the user the user-provided resource portion 210, by dragging and dropping an icon of the file, by providing a uniform resource locator (URL) associated with the file, etc.

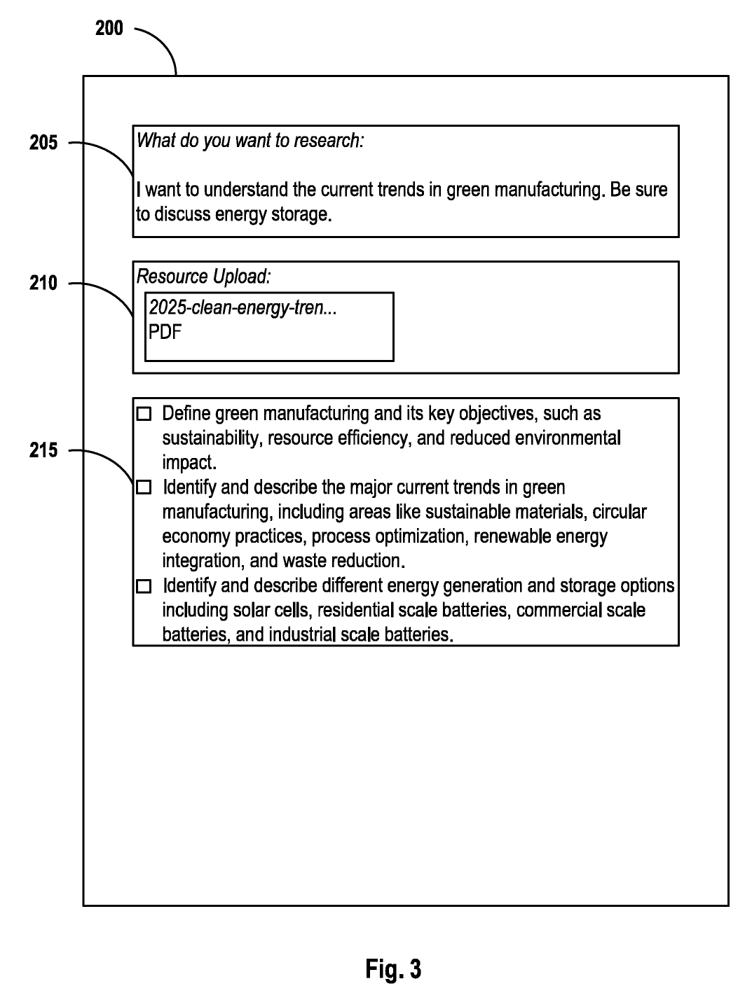

FIG. 3 depicts an example of an iteration of the user interface 200. As shown at 210, the user has provided a PDF file at the user-provided resource portion 210. FIG. 3 further depicts a research sub-task portion 215. As can be seen in FIG. 3, the research sub-task portion 215 can depict a plurality of research sub-tasks. The research sub-tasks can be generated based on a prompt that is associated with the user input in the user input portion 205. For example, the user might provide an input to the user input portion 205 of the user interface 200 (e.g., via user input engine 111 and/or application(s) 115 of companion device 110) such as: "I want to understand the current trends in green manufacturing. Be sure to discuss energy storage."

Based on the user input and/or the one or more resources, the NL based response system 120 could use one or more of VLM(s) 150 to generate sub-tasks such as the depicted sub-tasks at 215: “Define green manufacturing and its key objectives, such as sustainability, resource efficiency, and reduced environmental impact,” “Identify and describe the major current trends in green manufacturing, including areas like sustainable materials, circular economy practices, process optimization, renewable energy integration, and waste reduction,” and “Identify and describe different energy generation and storage options including solar cells, residential scale batteries, commercial scale batteries, and industrial scale batteries.” Indications of one or more of the sub-tasks could then be provided to the user as shown in FIG. 3, for example using rendering engine 112 and/or output device(s) 114 of the companion device 110 as previously described.

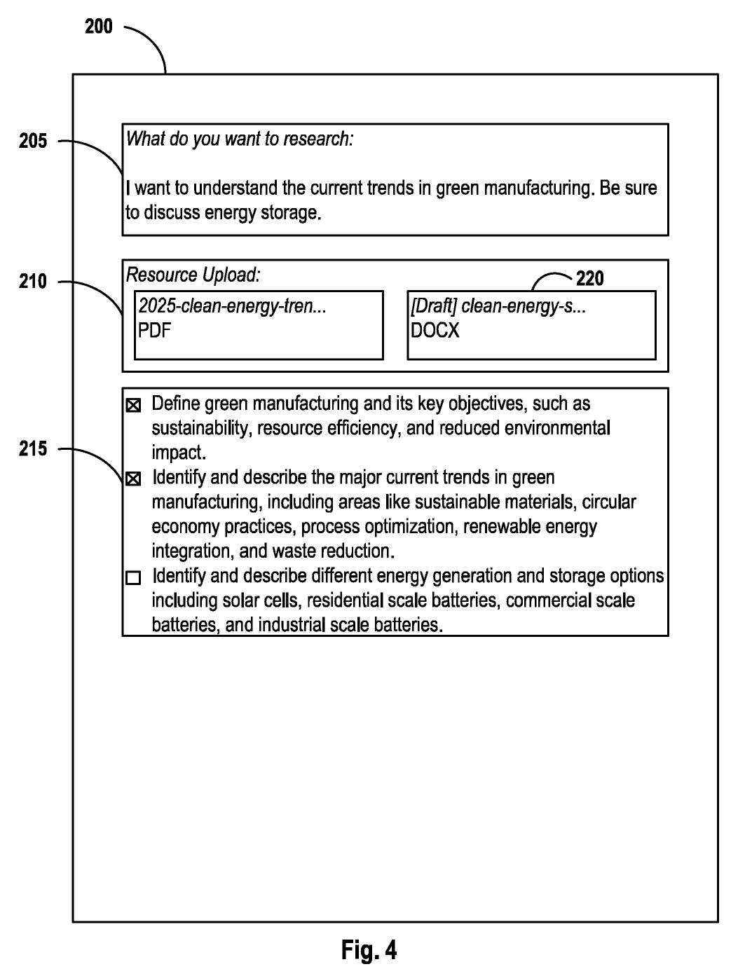

FIG. 4 depicts an example of a further iteration of the user interface 200. As previously described, the user can provide some form of feedback based on the depicted sub-tasks at 215. In this example, the user has provided feedback in two ways. Firstly, the user has selected the first two research sub-tasks depicted at 215 (as indicated by the "X" in the box next to each of the two sub-tasks), and the user has uploaded a DOCX document to the user-provided resource portion 210.

It will be understood, however, that the previous two examples of user feedback are provided for the sake of non-limiting examples, and other types of user feedback might be provided in other examples. For example, in the provided implementation, user selection of a sub-task might indicate which sub-tasks the user would like to have the system perform. However, in other implementations, selection of a sub-task might indicate which sub-tasks the user would like to have the system exclude. In some implementations, the user feedback could include feedback to one or more other elements. For example, the user might edit the user input at 205. In another example, the user might provide additional input (e.g., either at 205 or at some other area where the user is enabled to provide input). In some implementations, the user might be allowed to directly edit one or more of the sub-tasks and/or manually enter a new sub-task. A variety of other user-provided feedback mechanisms might additionally or alternatively be present in other embodiments. Non-limiting examples of user selection/de-selection/editing/etc. can include user actions such as hovering over a particular resource, clicking on the resource, gesturing to de-select a resource, vocalizing a selection of a resource, etc.

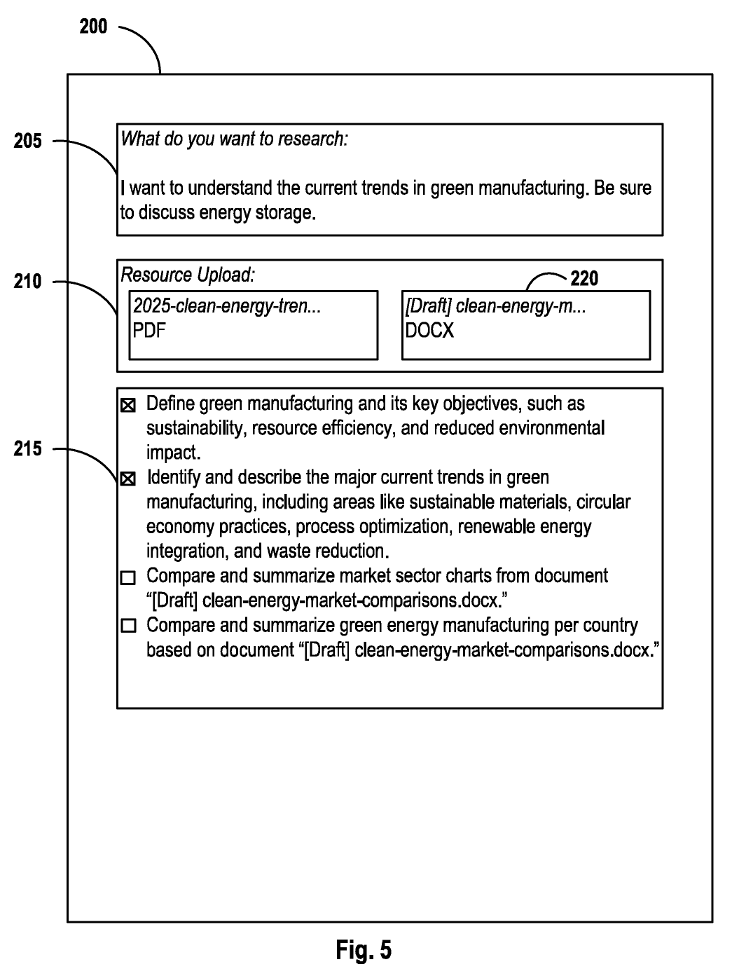

Based on the feedback provided by the user, the NL based response system 120 can generate one or more sub-tasks as depicted in FIG. 5. Specifically, in some implementations the NL based response system 120 can generate one or more research sub-tasks based on the user's alteration to the user input at 205, the user's alteration of one or more of the previously-rendered sub-tasks, etc. as previously described.

In some implementations, the NL based response system 120 can generate one or more sub-tasks based on content of one or more of the additional user-provided resources, as previously described. For example, as shown in FIG. 5, the system identified the user's upload of the "[Draft] clean-energy-market-comparisons.docx" document at 220. Based on the content of this document, the system generated two new research sub-tasks: "Compare and summarize market sector charts from document '[Draft] clean-energy-market-comparisons.docx.'" and "Compare and summarize green energy manufacturing per country based on document '[Draft] clean-energy-market-comparisons.docx.'" These newly generated sub-tasks are depicted at 215 alongside the previously rendered sub-tasks.

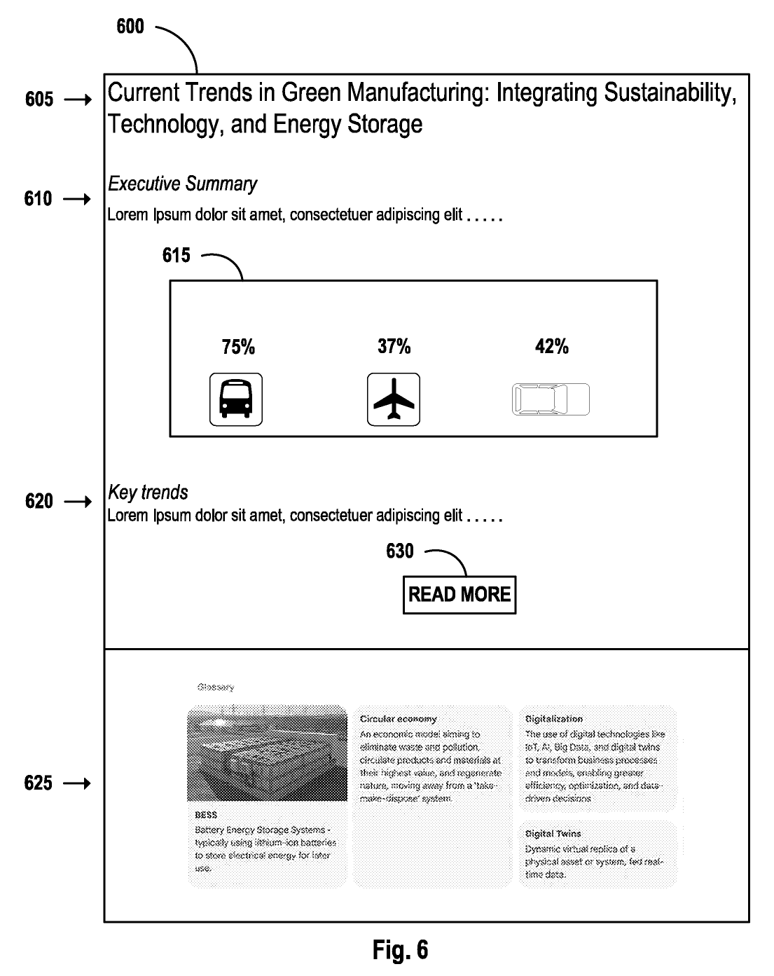

Based on one or more of the research task identified based on the user input at 205, the user-provided resources at 210, the one or more generated research sub-tasks at 215, and/or the user-selected resources at 220, the system of FIG. 1 can perform one or more of the identified research task and/or one or more of the research sub-tasks to generate research results as shown in FIG. 6.

As an example, FIG. 6 depicts an example of a research report 600 that can be generated based on the generated research results. As previously described, VLM input could be generated by the VLM input engine 124 using various of the above-described elements such as those of FIGS. 2-5. Using this VLM input, the NL based response system 120 could use one or more of the VLMs 150 to generate one or more responses (e.g., research results) based on the research task and/or research sub-task(s). As previously described, generation of the one or more responses could include generation of a variety of elements with textual and/or non-textual data representations that could subsequently be provided to the user via the user interface 200 and/or rendering engine 112 of the companion device 110.

In this specific example, FIG. 6 presents different data representations of information related to current trends in green manufacturing within a research report 600. As previously noted, the data representations shown can be based on results generated from performing a research task or one or more research sub-tasks. Specifically, section 610 provides an "Executive Summary" utilizing a textual data representation. This representation presents a high-level overview of the topic using written language, indicated by the placeholder text. Section 615 depicts a placeholder visualization resembling a bar chart, which exemplifies a non-textual visual data representation. While the data is not explicitly shown in this placeholder, such a representation can convey quantitative or comparative data derived from the research results in a graphical format. Section 625 illustrates a "Glossary" section, which uses a textual data representation formatted as definitions for specific terms related to the research topic, such as "Battery Energy Storage Systems (BESS)," "Circular economy," "Digitalization," and "Digital Twins." This presentation allows for the clear and concise definition of key terminology. Section 620 presents a "Key trends" section, also employing a textual data representation to describe significant developments or patterns identified through the research, again indicated by placeholder text. Section 630 includes a "READ MORE" link, which, while presented textually, could potentially lead to an interactive data representation or a different data representation not explicitly depicted, allowing a user to explore the information further. These different data representations allow a user to interact with and understand the same underlying research results in various formats tailored to different needs and preferences.

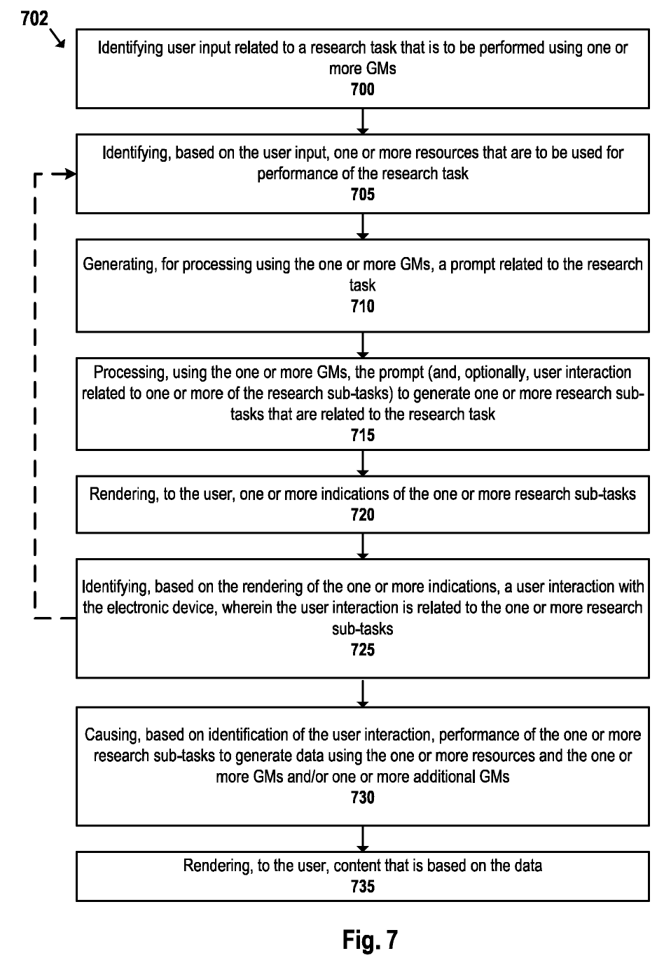

FIG. 7 depicts an example of a process 702 for practicing the operations of FIG. 7. It will be understood that the depicted process is intended as one example, and the process might vary in other implementations. For example, certain of the depicted elements could be combined into a single element. Additionally or alternatively, one or more of the depicted elements could be separated into different elements. Certain of the depicted elements could be performed in an order different than that shown. Various elements could be added, or various of the depicted elements could be excluded. Other variations might be present.

At block 700, the process 702 can include identifying user input related to a research task that is to be performed using one or more generative models (GMs). As described with respect to FIG. 2, the user input can be provided at user input portion 205 of user interface 200.

At block 705, the process 702 can include identifying, based on the user input, one or more resources that are to be used for performance of the research task. As discussed with respect to FIGS. 3-5, the resources can include user-provided resources such as the PDF document at 210 and/or the DOCX document at 220. Additionally or alternatively, the resources could be or include one or more resources that are identified by the NL based response system 120 based on the user provided input. For example, the one or more resources could be identified from an external source such as the internet, one or more academic repositories or databases, online video archives, etc.

At block 710, the process 702 can include generating, for processing using the one or more GMs, a prompt related to the research task. The prompt could be based on the user input and content of at least one of the one or more resources. For example, as described previously, the prompt can be generated based on various factors including the user input identified at block 700 and the resources identified at block 705.

At block 715, the process 702 can include processing, using the one or more GMs, the prompt to generate one or more research sub-tasks that are related to the research task. As illustrated at element 215 of FIGS. 3-5, the process can generate one or more research sub-tasks based on the prompt.

At block 720, the process 702 can include rendering, to the user, one or more indications of the one or more research sub-tasks. As depicted at 215 of FIGS. 3-5, the generated research sub-tasks can be presented to the user via the user interface 200.

At block 725, the process 702 can include identifying, based on the rendering of the one or more indications, a user interaction with the electronic device, wherein the user interaction is related to the one or more research sub-tasks. As shown in FIGS. 4 and 5, the user can interact with the rendered research sub-tasks, for instance by selecting certain sub-tasks for execution and deselecting others. User interaction at element 725 can additionally or alternatively involve editing the resources used in the research process, such as adding a new resource (like the DOCX document at 220), removing a resource, or modifying the content of an existing resource. If a change to one or more of the sub-tasks and/or the resources is identified at element 725, then the process can return to element 705, where the altered resource(s) is/are identified, and subsequently to element 715 for creating one or more new research sub-tasks based on the content of the altered resource(s).

At block 730, the process 702 can include causing, based on identification of the user interaction (for example, the user's selection or de-selection of one or more of the rendered sub-tasks), performance of the one or more research sub-tasks to generate data using the one or more resources and the one or more GMs and/or one or more additional GMs. Based on the user's interaction with the sub-tasks, the system can execute the selected or modified research sub-tasks, utilizing the identified resources and GMs.

At block 735, the process 702 can include rendering, to the user, content that is based on the data. As illustrated in FIG. 6, the generated data, such as a research report 600, can be presented to the user. In some implementations, the process can further include identifying and/or generating one or more of the previously described textual or non-textual data representations, and/or presenting options regarding to the data representations to the user and generating the content based on the user's feedback.

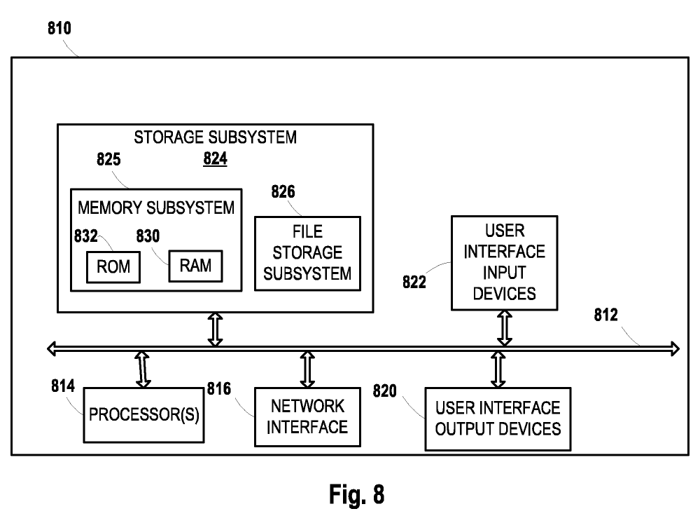

FIG. 8 is a block diagram of an example computer system 810. Computer system 810 typically includes processor(s) 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computer system 810. Network interface subsystem 816 provides an interface to outside networks and is coupled to corresponding interface devices in other computer systems.

In various implementations, computer system 810 could be or implement one or more of the companion device 110, the NL based response system 120, the application(s) 160, etc. In some implementations, the storage subsystem 824 could store one or more of VLMs 150, or implement one or both of storage devices 116/138.

User interface input devices 822 may include a keyboard, pointing devices such as a mouse, trackball, touchpad, or graphics tablet, a scanner, a touchscreen incorporated into the display, audio input devices such as voice recognition systems, microphones, and/or other types of input devices. In general, user interface input devices 822 may include any device for inputting information into computer system 810.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, user interface output devices 820 may include any device for outputting information from computer system 810 to the user or to another machine or computer system.

Storage subsystem 824 stores programming and data constructs that provide the functionality of some or all of the modules described herein. For example, the storage subsystem 824 may include the logic to perform selected aspects of the method of FIG. 7. These software modules are generally executed by processor(s) 814 alone or in combination with other processors. Processor(s) 814 may take various forms, such as a central processing unit (CPU), a graphics processing unit (GPU), a tensor processing unit (TPU), a neural processing unit (NPU), and so forth.

Memory 825 used in the storage subsystem 824 can include a number of memories including a main random access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computer system 810 communicate with each other as intended. Although bus subsystem 812 is shown schematically as a single bus, alternative implementations of the bus subsystem may use multiple busses.

Computer system 810 can be of varying types including a workstation, server, computing cluster, blade server, server farm, or any other data processing system or computing device. Due to the ever-changing nature of computers and networks, the description of computer system 810 depicted in FIG. 8 is intended only as a specific example for purposes of illustrating some implementations. Many other configurations of computer system 810 are possible having more or fewer components than the computer system depicted in FIG. 8.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used. Moreover, features described herein may be activated, deactivated, and reactivated at the individual’s discretion.

In various implementations, a computer-implemented method may include identifying user input by a user to an electronic device, where the user input may be related to a research task that is to be performed using one or more generative models (GMs). One or more resources that are to be used for performance of the research task may be identified based on the user input. For processing using the one or more GMs, a prompt related to the research task may be generated, where the prompt is based on the user input and content of at least one of the one or more resources. The prompt may be processed using the one or more GMs to generate one or more research sub-tasks that are related to the research task. One or more indications of the one or more research sub-tasks may be rendered to the user. Based on the rendering of the one or more indications, a user interaction with the electronic device may be identified, where the user interaction is related to the one or more research sub-tasks. Based on identification of the user interaction related to the one or more research sub-tasks, performance of the one or more research sub-tasks may be caused to generate data using the one or more resources and the one or more GMs and/or one or more additional GMs. Content that is based on the data may then be rendered to the user.

In some implementations, based on at least one research sub-task, a data representation of a portion of the content that is to be rendered based on the data may be identified. The portion of the content may be generated using the one or more GM based on the data and the identified data representation. Based on the performance of the research sub-tasks, the generated portion of the content may be rendered.

In various implementations, the data representation may be a textual data representation, and the generated portion of the content may be rendered as a textual element.

In various implementations, the data representation may be a non-textual visual data representation, and the generated portion of the content may be rendered as a non-textual visual element.

In various implementations, the data representation may be a non-textual audio data representation, and the generated portion of the content may be rendered as an audio element.

In various implementations, the data representation may be an interactive data representation, and the generated portion of the content may be rendered as an interactive element.

In various implementations, the one or more resources may include user-provided resources.

In various implementations, a research sub-task of the one or more research sub-tasks may include processing content of the user-provided resources.

In various implementations, a research sub-task of the one or more research sub-tasks may include excluding content from resources that are different from the user-provided resources.

In various implementations, a research sub-task of the one or more research sub-tasks may include identifying, based on the one or more research sub-tasks, one or more additional resources for use in performance of the one or more research sub-tasks.

In various implementations, generation of a research sub-task of the one or more research sub-tasks may be based on a topic of a resource of the one or more resources.

In various implementations, generation of a research sub-task of the one or more research sub-tasks may be based on a type of a resource of the one or more resources.

In various implementations, generation of a research sub-task of the one or more research sub-tasks may be based on a topic of the research task.

In various implementations, generation of a research sub-task of the one or more research sub-tasks may be based on a topic of a resource of the one or more resources.

In various implementations, the user interaction may be an active input that causes the electronic device to cause the performance of the one or more research sub-tasks.

In various implementations, the user interaction may be an active input that causes the electronic device to change at least one research sub-task of the one or more research sub-tasks prior to performance of the one or more research sub-tasks.

In some implementations, the active input may relate to a change to the one or more resources. Based on the changed at least one research sub-task and the changed one or more resources, a second prompt related to the research task may be generated. The second prompt may be processed using the one or more GMs and the changed one or more resources to generate the change to the at least one research sub-task.

In some implementations, an indication of the changed at least one research sub-task may be rendered prior to performance of the one or more research sub-tasks. Based on the rendering of the indication of the changed at least one research sub-task, a second user interaction with the electronic device may be identified, where the second user interaction is related to the one or more research sub-tasks.

Other implementations may include a transitory or non-transitory computer readable storage medium storing instructions executable by a processor to perform a method such as one or more of the methods described above. Yet another implementation may include a system including memory and one or more processors operable to execute instructions, stored in the memory, to implement one or more modules or engines that, alone or collectively, perform a method such as one or more of the methods described above.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer-implemented method comprising:
identifying user input by a user to an electronic device, wherein the user input is related to a research task that is to be performed using one or more generative models (GMs);
identifying, based on the user input, one or more resources that are to be used for performance of the research task;
generating, for processing using the one or more GMs, a prompt related to the research task, wherein the prompt is based on the user input and content of at least one of the one or more resources;
processing, using the one or more GMs, the prompt to generate one or more research sub-tasks that are related to the research task;
rendering, to the user, one or more indications of the one or more research sub-tasks;
identifying, based on the rendering of the one or more indications, a user interaction with the electronic device, wherein the user interaction is related to the one or more research sub-tasks;
causing, based on identification of the user interaction related to the one or more research sub-tasks, performance of the one or more research sub-tasks to generate data using the one or more resources and the one or more GMs and/or one or more additional GMs; and
rendering, to the user, content that is based on the data.

2. The computer-implemented method of claim 1, wherein the method further comprises:
identifying, based on at least research sub-task of the plurality of research sub-tasks, a data representation of a portion of the content that is to be rendered based on the data;
generating, using the one or more GM, the portion of the content based on the data and the identified data representation; and
rendering, based on the performance of the plurality of research sub-tasks, the generated portion of the content.

3. The computer-implemented method of claim 2, wherein the data representation is a textual data representation, and wherein the generated portion of the content is rendered as a textual element.

4. The computer-implemented method of claim 2, wherein the data representation is a non-textual visual data representation, and wherein the generated portion of the content is rendered as a non-textual visual element.

5. The computer-implemented method of claim 2, wherein the data representation is a non-textual audio data representation, and wherein the generated portion of the content is rendered as an audio element.

6. The computer-implemented method of claim 2, wherein the data representation is an interactive data representation, and wherein the generated portion of the content is rendered as an interactive element.

7. The computer-implemented method of claim 1, wherein the one or more resources are user-provided resources.

8. The computer-implemented method of claim 7, wherein a research sub-task of the one or more research sub-tasks includes processing content of the user-provided resources.

9. The computer-implemented method of claim 8, wherein a research sub-task of the one or more research sub-tasks includes excluding content from resources that are different from the user-provided resources.

10. The computer-implemented method of claim 1, wherein a research sub-task of the one or more research sub-tasks includes identifying, based on the one or more research sub-tasks, one or more additional resources for use in performance of the one or more research sub-tasks.

11. The computer-implemented method of claim 1, wherein generation of a research sub-task of the one or more research sub-tasks is based on a topic of a resource of the one or more resources.

12. The computer-implemented method of claim 1, wherein generation of a research sub-task of the one or more research sub-tasks is based on a type of a resource of the one or more resources.

13. The computer-implemented method of claim 1, wherein generation of a research sub-task of the one or more research sub-tasks is based on a topic of the research task.

14. The computer-implemented method of claim 1, wherein generation of a research sub-task of the one or more research sub-tasks is based on a topic of a resource of the one or more resources.

15. The computer-implemented method of claim 1, wherein the user interaction is an active input that causes the electronic device to cause the performance of the one or more research sub-tasks.

16. The computer-implemented method of claim 1, wherein the user interaction is an active input that causes the electronic device to change at least one research sub-task of the one or more research sub-tasks prior to performance of the one or more research sub-tasks.

17. The computer-implemented method of claim 16, wherein the active input relates to a change to the one or more resources, and wherein the method further comprises:
generating, based on the changed at least one research sub-task and the changed one or more resources, of a second prompt related to the research task; and
processing the second prompt using the one or more GMs and the changed one or more resources to generate the change to the at least one research sub-task.

18. The computer-implemented method of claim 16, wherein the method further comprises:
rendering an indication of the changed at least one research sub-task prior to performance of the one or more research sub-tasks; and
identifying, based on the rendering of the indication of the changed at least one research sub-task, a second user interaction with the electronic device, wherein the second user interaction is related to the one or more research sub-tasks.

19. One or more non-transitory computer-readable media comprising instructions that, upon execution of the instructions by one or more processors of one or more electronic devices, are to cause the one or more electronic devices to:
identify user input by a user to an electronic device of the one or more electronic devices, wherein the user input is related to a research task that is to be performed using one or more generative models (GMs);
identify, based on the user input, one or more resources that are to be used for performance of the research task;
generate, for processing using the one or more GMs, a prompt related to the research task, wherein the prompt is based on the user input and content of at least one of the one or more resources;
process, using the one or more GMs, the prompt to generate one or more research sub-tasks that are related to the research task;
render, to the user, one or more indications of the one or more research sub-tasks;
identify, based on the rendering of the one or more indications, a user interaction with the electronic device, wherein the user interaction is related to the one or more research sub-tasks;
cause, based on identification of the user interaction related to the one or more research sub-tasks, performance of the one or more research sub-tasks to generate data using the one or more resources and the one or more GMs and/or one or more additional GMs; and
render, to the user, content that is based on the data.

20. A system comprising:
one or more processors of one or more electronic devices; and
one or more non-transitory computer-readable media comprising instructions that, upon execution of the instructions by the one or more processors, are to cause the one or more electronic devices to:
identify user input by a user to an electronic device, wherein the user input is related to a research task that is to be performed using one or more generative models (GMs);
identify, based on the user input, one or more resources that are to be used for performance of the research task;
generate, for processing using the one or more GMs, a prompt related to the research task, wherein the prompt is based on the user input and content of at least one of the one or more resources;
process, using the one or more GMs, the prompt to generate one or more research sub-tasks that are related to the research task;
render, to the user, one or more indications of the one or more research sub-tasks;
identify, based on the rendering of the one or more indications, a user interaction with the electronic device, wherein the user interaction is related to the one or more research sub-tasks;
cause, based on identification of the user interaction related to the one or more research sub-tasks, performance of the one or more research sub-tasks to generate data using the one or more resources and the one or more GMs and/or one or more additional GMs; and
render, to the user, content that is based on the data.
